(19) United States
(12) Patent Application Publication
(10) Pub. No.: US 2023/0259844 A1
(43) Pub. Date: Aug. 17, 2023

(54) SYSTEMS AND METHODS FOR DETERMINING A PARKING SPACE STATUS USING AN ELECTRIC VEHICLE CHARGING STATION

(71) Applicant: Volta Charging, LLC, San Francisco, CA (US)

(72) Inventors: Jeffrey Kinsey, San Mateo, CA (US); Ramsey Meyer, San Francisco, CA (US); Michael Clement, Monterey, CA (US)

(21) Appl. No.: 17/954,712

(22) Filed: Sep. 28, 2022

Related U.S. Application Data
(60) Provisional application No. 63/250,374, filed on Sep. 30, 2021.

(51) Int. Cl. G06Q 10/0631; B60L 53/66; G08G 1/14; G06Q 50/06

(52) U.S. Cl. CPC G06Q 10/06314; B60L 53/66; G06Q 50/06; G08G 1/141

(57) ABSTRACT

Systems and methods are provided herein for identifying the status of an electric vehicle charging station’s (EVCS) parking space. This may be accomplished by an EVCS detecting an electric vehicle in a parking space using one or more sensors. The EVCS can use the one or more sensors to receive user information relating to the detected electric vehicle. The EVCS can then determine a status (e.g., “Occupied,” “Soon to be occupied,” “Available,” “Soon to be available,” etc.) of the parking space using the received user information. The EVCS then transmits the status to a device (e.g., server, smartphone, etc.).

### BACKGROUND

The present disclosure relates to computer-implemented techniques for charging electric vehicles, and in particular to techniques for allocating parking spaces to electric vehicles.

### SUMMARY

As more consumers transition to electric vehicles, there is an increasing demand for electric vehicle charging stations (EVCSs). These EVCSs usually supply electric energy, either using cables or wirelessly, to the batteries of electric vehicles. For example, a user can connect their electric vehicle via cables of an EVCS and the EVCS supplies electrical current to the user’s electric vehicle. The cables and control systems of the EVCSs can be housed in kiosks in locations to allow a driver of an electric vehicle to park the electric vehicle close to the EVCS and begin the charging process. These kiosks may be placed in areas of convenience, such as in parking lots at shopping centers, in front of commercial buildings, or in other public places. With more electric vehicles on the road than ever before, there are often situations where the number of electric vehicles requiring a charge outnumbers the available EVCSs. Said situations can result in prolonged wait times, suboptimal charging allocation, electric vehicles running out of charge, and/or an overall poor user experience. In view of these deficiencies, there exists a need for improved systems and methods for EVCS service management.

Various systems and methods described herein address these problems by providing a method for identifying the status of a parking space to better allocate EVCS services. The status of a parking space relates to the availability (e.g., “Occupied,” “Soon to be occupied,” “Available,” “Soon to be available,” etc.) of the parking space. For example, when an electric vehicle is parked in a parking space, the parking space status may be “Occupied” and when no electric vehicle is parked in the parking space, the parking space status may be “Available.” When an electric vehicle is parked in the parking space and the EVCS determines that the electric vehicle will be moving within a time period (e.g., 10 minutes), the parking space status may be “Soon to be available” and/or indicate the estimated time period (e.g., 10 minutes) when the parking space will be available. When an electric vehicle is not parked in the parking space and the EVCS determines that the electric vehicle will be parking in the parking space within a time period (e.g., 10 minutes), the parking space status may be “Soon to be occupied” and/or indicate the estimated time period (e.g., 10 minutes) until the parking space will be occupied.

As described herein, one methodology for an EVCS to identify the status of a parking space is for the EVCS to first determine if an electric vehicle is located in the parking space. The EVCS may use one or more sensors (e.g., image sensors, ultrasound sensors, proximity sensors, etc.) to determine if an electric vehicle is located in the parking space. For example, the EVCS may use a camera (sensor) to determine if an electric vehicle is located in the parking space. The EVCS may also determine if an electric vehicle is located in the parking space based on whether the EVCS is plugged into the electric vehicle. If there is an electric vehicle in the parking space, the EVCS may make a preliminary estimate that the parking space is occupied. If there is no electric vehicle in the parking space, the EVCS may make a preliminary estimate that the parking space is available. The EVCS may then use the preliminary estimate and user information (e.g., user activity, user location, user calendars, user purchases, user patterns, etc.) to determine the status of the parking space. For example, the EVCS may use the preliminary estimate (e.g., “Occupied”) along with user information (e.g., the user is loading groceries into the electric vehicle) to determine that the status of the parking space is “Soon to be available.” The EVCS can then transmit the parking space status to a user device, a server, or similar such device to help allocate EVCS services. For example, the EVCS may transmit the parking space status (“Soon to be available”) to a user device of a second user, wherein the second user requires a parking space for charging their electric vehicle.

The EVCS can determine that the received user information relates to estimated time periods. For example, the EVCS may access a database with entries that associate user information with estimated time periods. A first entry may indicate that a user loading groceries (user activity) into an electric vehicle parked at the EVCS’s parking space corresponds to approximately 10 minutes (time period) until the electric vehicle leaves the parking space. A second entry may indicate that a user of an electric vehicle parked in the EVCS’s parking space paying for an item at a store (user purchase) corresponds to five minutes (time period) until the electric vehicle leaves the parking space, because the user has to walk to the electric vehicle from the store. The entries may provide increasing granularity. For example, entries may specify that users with children loading groceries may correspond to a longer time period than users without children loading groceries. In another example, based on past behavior of users, some entries may specify that a first user doing an activity may correspond to a longer time period than a second user doing the same activity. In some embodiments, the EVCS uses a dwell time of the user to determine the parking space status. In some applications, dwell times can be determined using a number of factors, such as U.S. Application No. 63/218,770, the disclosure of which is hereby incorporated by reference herein in its entirety.

The EVCS may transmit the parking space status to a user or group of users based on one or more factors (e.g., proximity, queue, auction, electric vehicle information, user information, etc.). For example, the EVCS may transmit the parking space status (“Soon to be available”) to a user who requires a parking space to charge their electric vehicle within a threshold distance (e.g., one mile). In another example, the EVCS may transmit the parking space status to a group of users who subscribe to a spot notification service. In another example, the EVCS may transmit the parking space status to users with electric vehicles having a charge below a first threshold (e.g., less than 20% charged).

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1 shows an illustrative diagram of a system for identifying the status of a parking space, in accordance with some embodiments of the disclosure;

FIGS. 2A and 2B show block diagrams of an illustrative process for identifying the status of a parking space, in accordance with some embodiments of the disclosure;

FIGS. 3A-3D show block diagrams of an illustrative process for identifying the status of a parking space, in accordance with some embodiments of the disclosure;

FIGS. 4A and 4B show illustrative diagrams of a user device generating parking space status notifications, in accordance with some embodiments of the disclosure;

FIG. 5 shows an illustrative block diagram of an EVCS system, in accordance with some embodiments of the disclosure;

FIG. 6 shows an illustrative block diagram of a user equipment device system, in accordance with some embodiments of the disclosure;

FIG. 7 shows an illustrative block diagram of a server system, in accordance with some embodiments of the disclosure;

FIG. 8 is an illustrative flowchart of a process for identifying the status of a parking space, in accordance with some embodiments of the disclosure;

FIG. 9 is another illustrative flowchart of a process for identifying the status of a parking space, in accordance with some embodiments of the disclosure; and

FIG. 10 is another illustrative flowchart of a process for identifying the status of a parking space, in accordance with some embodiments of the disclosure.

### DETAILED DESCRIPTION

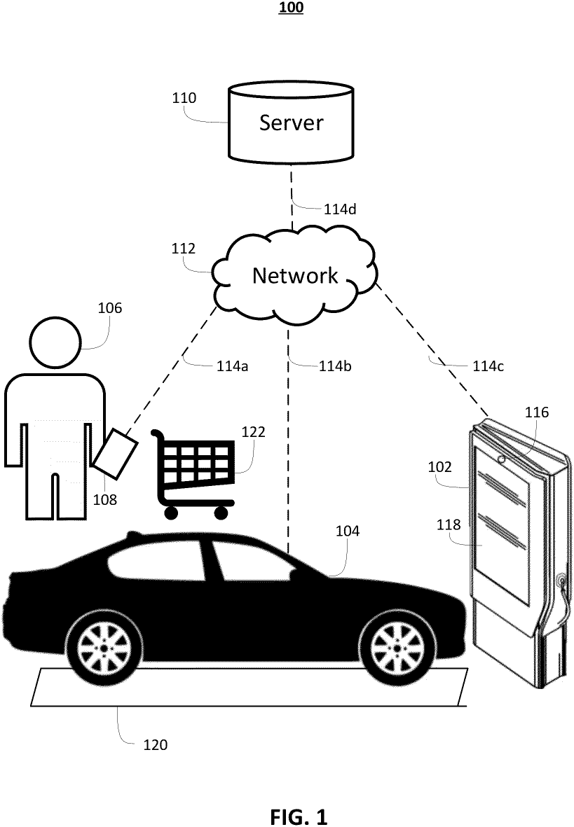

FIG. 1 shows an illustrative diagram of a system 100 for identifying the status of a parking space 120, in accordance with some embodiments of the disclosure. In some embodiments, the EVCS 102 provides an electric charge to the electric vehicle 104 in the parking space 120 via a wired connection, such as a charging cable, or a wireless connection (e.g., wireless charging). The EVCS 102 may be in communication with the electric vehicle 104 and/or a user device 108 belonging to a user 106 (e.g., a driver, passenger, owner, renter, or other operator of the electric vehicle 104) that is associated with the electric vehicle 104. In some embodiments, the EVCS 102 communicates with one or more devices or computer systems, such as user device 108 or server 110, respectively, via a network 112.

In the system 100, there can be more than one EVCS 102, electric vehicle 104, user, 106, user device 108, server 110, and network 112, but only one of each is shown in FIG. 1 to avoid overcomplicating the drawing. In addition, a user 106 may utilize more than one type of user device 108 and more than one of each type of user device 108. In some embodiments, there may be paths 114a-d between user devices, EVCSs, servers, and/or electric vehicles, so that the items may communicate directly with each other via communication paths, as well as other short-range point-to-point communication paths, such as USB cables, IEEE 1394 cables, wireless paths (e.g., Bluetooth, infrared, IEEE 802-11x, etc.), or other short-range communication via wired or wireless paths. In some embodiments, the devices may also communicate with each other directly through an indirect path via a communications network. The communications network may be one or more networks including the Internet, a mobile phone network, mobile voice or data network (e.g., a 4G, 5G, or LTE network), cable network, public switched telephone network, or other types of communications network or combinations of communications networks. In some embodiments, a communication network path comprises one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, a communication network path can be a wireless path. Communication with the devices may be provided by one or more communication paths but is shown as a single path in FIG. 1 to avoid overcomplicating the drawing.

In some embodiments, the EVCS 102 determines a status of the parking space 120 by determining if an electric vehicle is located in the parking space 120. To determine if an electric vehicle is located in the parking space 120, the EVCS 102 can use parking space information received from one or more sensors. In some embodiments, the EVCS 102 uses one or more sensors to capture parking space information. For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof. In some embodiments, one or more cameras 116 are configured to capture one or more images of an area proximal to the EVCS 102. For example, a camera may be configured to obtain a video or capture images of an area corresponding to the parking space 120 associated with the EVCS 102, a parking space next to the parking space 120 of the EVCS 102, and/or walking paths (e.g., sidewalks) next to the EVCS 102. In some embodiments, the camera 116 may be a wide-angle camera or a 360° camera that is configured to obtain a video or capture images of a large area proximal to the EVCS 102. In some embodiments, the camera 116 may be positioned at locations on the EVCS 102 different from what is shown. In some embodiments, the camera 116 works in conjunction with other sensors. In some embodiments, the one or more sensors (e.g., camera 116) can detect external objects within a region (area) proximal to the EVCS 102. In some embodiments, the EVCS 102 uses the parking space information (e.g., images from the camera 116) to determine that an electric vehicle 104 is located in the parking space 120.

In some embodiments, the EVCS 102 uses the parking space information to determine a parking space status. For example, if the EVCS 102 determines that the electric vehicle 104 is located in the parking space 120, the EVCS 102 can determine that the parking space status is a first status (e.g., “Occupied”). If the EVCS 102 determines that the parking space 120 is available, the EVCS 102 can determine that the parking space status is a second status (e.g., “Available”).

In some embodiments, the EVCS 102 uses user information (e.g., user activity, user location, user calendars, user purchases, user patterns, etc.) to update the parking space status. In some embodiments, to update a status of the parking space 120 using user information, the EVCS 102 determines a user 106 associated with the electric vehicle 104. In some embodiments, the user 106 may have to present some credentials (e.g., password, pin, biometrics, device, item, etc.) when requesting the EVCS 102 to charge their electric vehicle 104. For example, the user 106 may enter a password on the display 118 of the EVCS 102. In another example, the user 106 may enter a biometric password (e.g., fingerprint) on the user device 108, which is then communicated to the EVCS 102 and/or the server 110 via the network 112. In some embodiments, the credentials may be automatically inputted. For example, the user device 108 may automatically transmit user credentials to the EVCS 102 when the user device 108 is within a threshold distance of the EVCS 102. In some embodiments, the EVCS 102 uses characteristics of the electric vehicle 104 as credentials. For example, the EVCS 102 may automatically obtain characteristics of the electric vehicle 104 using ISO 15118 when the user 106 plugs in their electric vehicle 104. In some embodiments, the EVCS 102 uses the credentials to identify a user profile associated with the user 106. For example, the EVCS 102 may access a database (e.g., located on server 110) that associates credentials with a user profile. In some embodiments, the user profile stores information about the user 106. For example, the user profile may store user information related to the user 106, vehicle information of the electric vehicle 104 related to the user 106, and/or similar such information.

In some embodiments, the EVCS 102 uses user information obtained from the one or more sensors (e.g., camera 116) to update the parking space status. For example, the camera 116 may determine a first user activity (e.g., loading groceries 122) based on the camera 116 capturing images of the user 106 participating in the first activity (e.g., user 106 with groceries 122). In some embodiments, the EVCS 102 changes the parking space status (“Occupied”) to an updated parking space status (“Soon to be available”) using the user information (e.g., loading groceries 122).

In some embodiments, the EVCS 102 uses the received user information to determine an estimated time period for the updated parking space status. For example, the EVCS 102 may access a database with entries that associate user information with estimated time periods. In some embodiments, a first entry indicates that the user 106 loading groceries 122 (user activity) into the electric vehicle 104 parked in the parking space 120 corresponds to approximately 10 minutes (time period) until the electric vehicle 104 leaves the parking space 120. In some embodiments, a second entry indicates that the user 106 of the electric vehicle 104 parked in the parking space 120 paying for an item at a store (user purchase) corresponds to five minutes (time period) until the electric vehicle 104 leaves the parking space 120. In some embodiments, the entries provide additional granularity. For example, entries may specify that users with children loading groceries may correspond to a longer time period than users without children loading groceries. In some embodiments, the database comprises customized entries based on certain users. For example, based on past behavior of the user 106, some entries may specify that the user 106 doing an activity (e.g., loading groceries 122) may correspond to a longer time period than a second user doing the same activity. In some embodiments, the EVCS 102 includes the estimated time period in and/or along with the updated parking space status. For example, the updated parking space status may be “Will be available in 10 minutes.”

In some embodiments, the EVCS 102 transmits the parking space status to the first user 106, a second user, and/or group of users based on one or more factors (e.g., proximity, queue, auction, electric vehicle information, user information, etc.). In some embodiments, the EVCS 102 transmits a parking space status (“Soon to be available”) to a second user who requires a parking space to charge their electric vehicle within a threshold distance (e.g., one mile). In some embodiments, the EVCS 102 transmits the parking space status to a group of users who subscribe to a spot notification service. In some embodiments, the EVCS 102 transmits the parking space status to one or more users with electric vehicles having a charge below a first threshold (e.g., less than 20% charged). In some embodiments, there is a queue of users requesting parking spaces, and the EVCS 102 transmits the parking space status to a second user who is next in the queue to receive a parking space. In some embodiments, the EVCS 102 transmits the parking space status to a database comprising a plurality of entries listing parking space statuses. In some embodiments, the EVCS 102 displays the parking space status on the display 118.

In some embodiments, the EVCS 102 uses characteristics (e.g., model, make, specifications, condition, etc.) of the electric vehicle 104 to determine the parking space status. For example, the EVCS 102 may determine an electric vehicle characteristic that the electric vehicle’s battery is 95% charged. In some embodiments, the EVCS 102 uses the characteristics of the electric vehicle 104 (battery being 95% charged) to determine that the electric vehicle 104 is almost done charging and will likely leave the parking space 120 once charging is complete. In some embodiments, the EVCS 102 uses the characteristics of the electric vehicle 104 (battery being 95% charged) to determine that the parking space status is “Soon to be available.”

In some embodiments, the EVCS 102 uses characteristics of the electric vehicle 104 in conjunction with the user information to determine the parking space status. In some embodiments, the EVCS 102 uses a characteristic of the electric vehicle 104 (battery being 5% charged) in conjunction with user information (no calendar events) to determine the parking space status to be “Will be occupied for one hour.” In some embodiments, the EVCS 102 makes this determination because users assume that they will spend more time at a location comprising an EVCS when their electric vehicle has a low battery percentage because it takes more time to charge an electric vehicle with a low battery percentage. In some embodiments, the EVCS 102 also displays a first media item (e.g., movie ticket sale) on the display 118 for the user 106 because the first media item corresponds to an activity with a timeframe similar to the parking state status (e.g., “Will be occupied for one hour”). In some embodiments, the EVCS 102 uses a characteristic of the electric vehicle 104 (battery being 90% charged) in conjunction with user information (no calendar events) to determine the parking space status to be “Will be available in 15 minutes.” In some embodiments, the EVCS 102 makes this determination because users assume that they will not spend as much time at a location comprising an EVCS when their electric vehicle has a higher battery percentage, because it takes less time to charge an electric vehicle with a higher battery percentage. In some embodiments, the EVCS 102 displays a second media item (e.g., coffee sale) for the user 106 because the second media item corresponds to an activity with a timeframe similar to the parking state status (e.g., “Will be available in 15 minutes”).

In some embodiments, the EVCS 102 uses location information (e.g., local patterns, electrical grid information, site information, etc.) to determine the parking space status. For example, the user 106 may request the EVCS 102 to charge their electric vehicle 104 at a first time of day, and the EVCS 102 can retrieve location information (e.g., average charging time for users during the first time of day is one hour). In some embodiments, the EVCS 102 uses the location information (e.g., average charging time for users during the first time of day is one hour) to determine that the parking space status is “Will be occupied for one hour.”

In some embodiments, the EVCS 102 uses location information in conjunction with user information to determine the parking space status. For example, the user 106 may request the EVCS 102 to start charging their electric vehicle 104, and the EVCS 102 may retrieve a first user information indicating that the user 106 purchased an item for pickup from a location (e.g., restaurant) within a threshold distance (e.g., one mile) from the EVCS 102. In some embodiments, the EVCS 102 determines a first local pattern, that users who purchased an item for pickup from the location wait an average timeframe (e.g., 15 minutes). In some embodiments, the EVCS 102 uses the location information (that users who purchased an item for pickup from the location wait an average of 15 minutes) in conjunction with user information (the user 106 purchased the item for pickup from the location) to determine that the parking space status is “Will be available in 15 minutes.”

In some embodiments, the EVCS 102 leverages machine learning to determine the parking space statuses, user information, electric vehicle characteristics, location information, and/or similar such information. The EVCS may use any combination of user information, electric vehicle characteristics, location information, and/or similar such information to determine the parking space statuses.

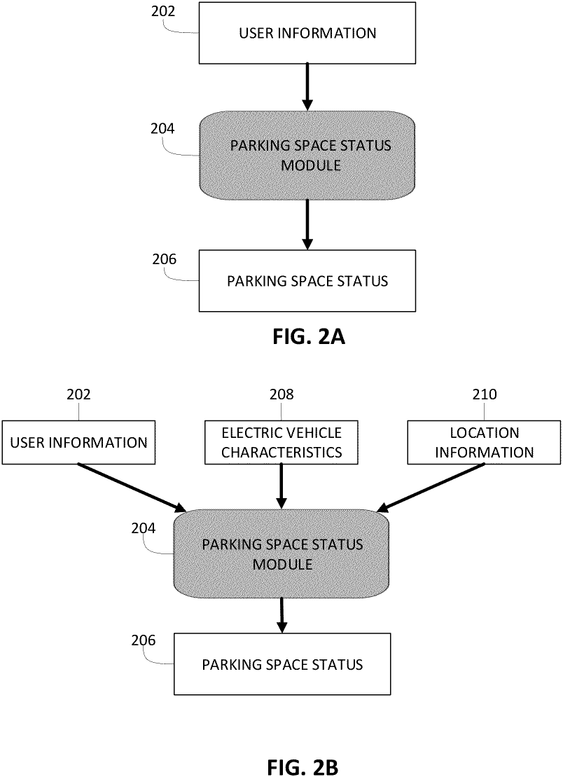

FIGS. 2A and 2B show block diagrams of an illustrative process for identifying the status of a parking space, in accordance with some embodiments of the disclosure. In some embodiments, FIGS. 2A and 2B use the same or similar methods and devices described in FIG. 1.

FIG. 2A shows a parking space status module 204 receiving user information 202 and outputting a parking space status 206. In some embodiments, the parking space status 206 corresponds to the parking space statuses (e.g., initial parking space status, updated parking space status, etc.) described in FIG. 1. As described herein, the parking space status module 204 may be located in an EVCS (e.g., EVCS 102), a server (e.g., server 110), a user device (e.g., user device 108) and/or any combination thereof. In some embodiments, the parking space status module 204 has access to parking space information received from one or more sensors.

In some embodiments, to determine the parking space status 206, the parking space status module 204 uses user information 202 (e.g., user location, user calendars, user purchases, user patterns, etc.). The parking space status module 204 has a variety of methods of obtaining the user information 202 (e.g., receiving the user information 202 from a database, receiving the user information 202 from a user, receiving the user information 202 from a third-party provider, etc.). The parking space status module 204 can use one piece of user information 202 or a plurality of user information to determine the parking space status 206. In some embodiments, different user information is weighted according to significance. For example, a first piece of user information indicating that the user has an upcoming event may be weighted higher than a second piece of user information indicating that the user made a purchase two weeks ago. In some embodiments, the parking space status module 204 uses the different weights in determining the parking space status 206. In some embodiments, the parking space status module 204 outputs the parking space status 206 to an EVCS (e.g., EVCS 102), a server (e.g., server 110), a user device (e.g., user device 108) and/or any combination thereof.

FIG. 2B shows a parking space status module 204 receiving user information 202, electric vehicle characteristics 208, and location information 210 and outputting a parking space status 206. In some embodiments, FIG. 2B generates a parking space status 206 in the same or similar way as described above in FIG. 2A. In some embodiments, the parking space status module 204 uses any combination of parking space information, user information 202, electric vehicle characteristics 208, location information 210, and/or similar such information to determine the parking space status 206. In some embodiments, the parking space status module 204 receives only the user information 202 and the electric vehicle characteristics 208 and determines the parking space status 206. In some embodiments, the parking space status module 204 receives only the user information 202 and the location information 210 and determines the parking space status 206. The parking space status module 204 can use one or more pieces of parking space information, user information 202, electric vehicle characteristics 208, and/or location information 210 to determine the parking space status 206. In some embodiments, different information is weighted according to significance. In some embodiments, the parking space status module 204 uses the different weights in determining the parking space status 206. In some embodiments, the parking space status module 204 outputs the parking space status 206 to an EVCS (e.g., EVCS 102), a server (e.g., server 110), a user device (e.g., user device 108) or any combination thereof.

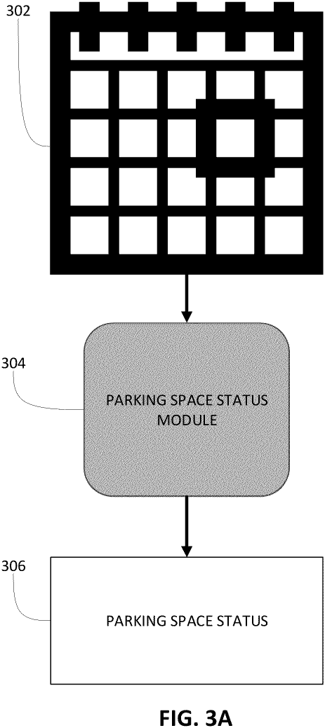

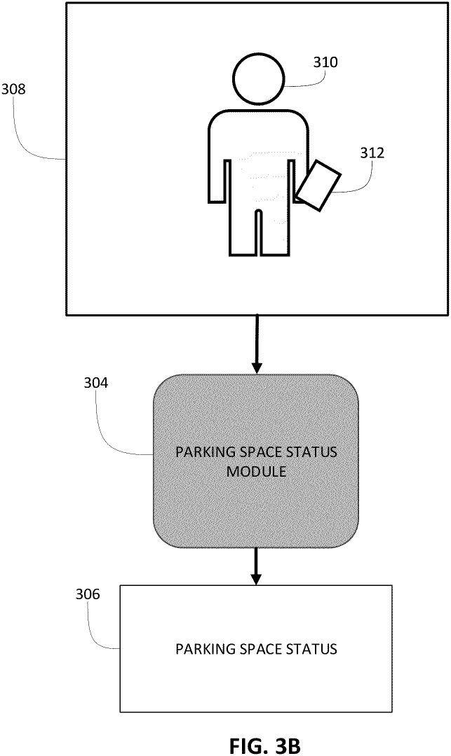

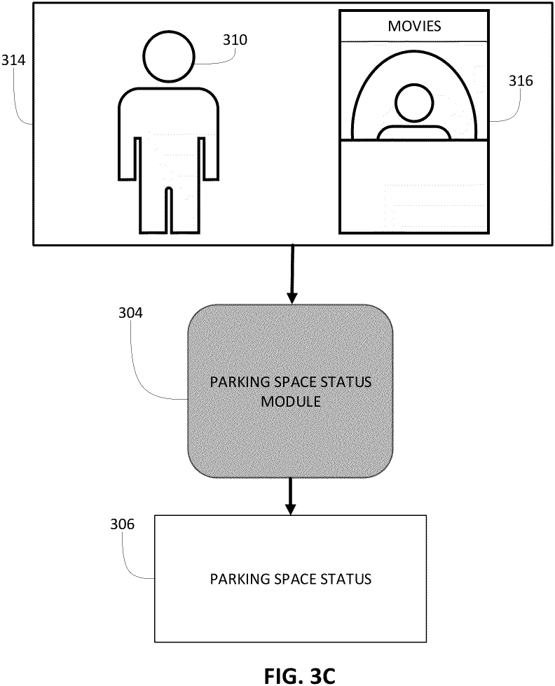

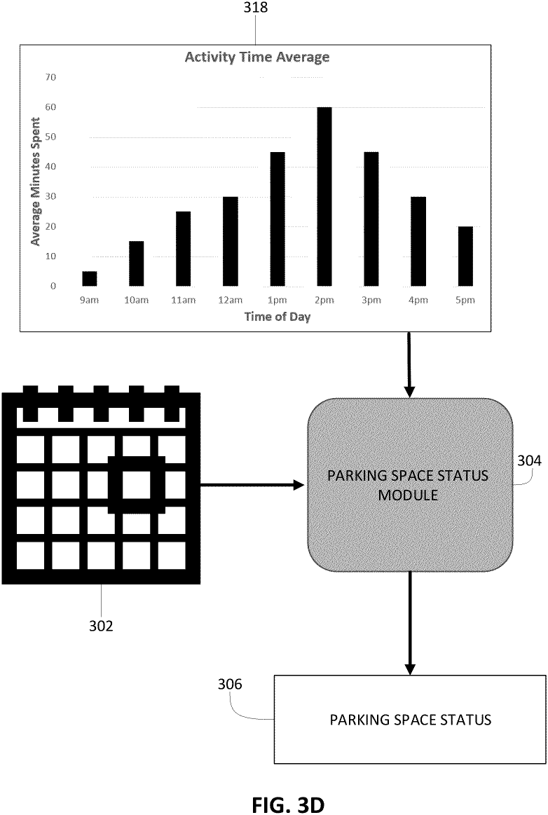

FIGS. 3A-3D show block diagrams of an illustrative process for identifying the status of a parking space, in accordance with some embodiments of the disclosure. In some embodiments, the parking space status 306 corresponds to the parking space statuses (e.g., initial parking space status, updated parking space status, etc.) described in FIGS. 1-2B. As described herein, the parking space status module 304 may be located in an EVCS (e.g., EVCS 102), a server (e.g., server 110), a user device (e.g., user device 108) or any combination thereof. In some embodiments, the parking space status module 304 has access to parking space information received from one or more sensors.

FIG. 3A shows an embodiment of a parking space status module 304 receiving a user’s calendar information 302 (user information) and outputting a parking space status 306. In some embodiments, the parking space status module 304 uses the user’s calendar information 302 when determining the parking space status 306. For example, the user may request an EVCS to start charging their electric vehicle at 1:00 pm, and the parking space status module 304 may receive a user’s calendar information 302 indicating that the user has an event, located within the vicinity of the EVCS, ending at 3:00 pm. In some embodiments, the parking space status module 304 uses the user’s calendar information 302 to determine that the parking space status 306 is “Occupied until 3:00 pm.”

FIG. 3B shows an embodiment of a parking space status module 304 receiving a geofence notification (user information) and outputting a parking space status 306. In some embodiments, the parking space status module 304 uses the geofence notification to determine the parking space status 306. For example, an EVCS may detect an electric vehicle associated with a user 310 using parking space information, and the parking space status module 304 may receive a geofence notification indicating that a device 312 associated with the user 310 crossed a geofence 308 at 1:05pm. In some embodiments, the parking space status module 304 uses the geofence notification to determine the parking space status 306 (e.g., “Will be available at 1:20 pm”) based on the amount of time that the user has spent in the location related to the geofence 308 in the past. In some embodiments, the parking space status module 304 receives past user behavior patterns indicating that the user 310 spent an average amount of time (e.g., 15 minutes) in the location related to the geofence 308. In some embodiments, the location related to the geofence 308 may correspond to a parking space status (e.g., coffee shops correspond to 15 minutes until the parking space is available, movie theaters correspond to two hours until the parking space is available, etc.).

FIG. 3C shows an embodiment of a parking space status module 304 receiving a purchase notification 314 (user information) and outputting a parking space status 306. In some embodiments, the parking space status module 304 uses the purchase notification 314 to determine the parking space status 306. For example, the EVCS may detect an electric vehicle associated with a user 310 using parking space information, and the parking space status module 304 may retrieve a purchase notification indicating that the user 310 purchased a movie ticket 316 for a movie lasting a first time period (e.g., two hours). In some embodiments, the parking space status module 304 uses the purchase notification 314 to determine the parking space status 306 (e.g., “Will be occupied for two hours”).

FIG. 3D shows an embodiment of a parking space status module 304 receiving a user’s calendar information 302 (user information) and location trends 318 (location information) and outputting a parking space status 306. In some embodiments, the parking space status module 304 uses the user’s calendar information 302 and location trends 318 to determine the parking space status 306. In some embodiments, the EVCS detects an electric vehicle associated with a user in a parking space using parking space information. In some embodiments, the parking space status module receives the user’s calendar information 302 indicating that the user has an event (e.g., haircut) occurring at a location. In some embodiments, the user’s calendar information 302 is ambiguous regarding the time period of the event. In some embodiments, the location trends 318 received by the parking space status module 304 comprise the dwelling trends of the location. In some embodiments, the dwelling trends can relate to amount of time users normally spend in the location. For example, users may spend different amounts of time in different locations (e.g., average of 10 minutes in coffee shops, average of two hours in restaurants, etc.). In some embodiments, the dwell trends indicate that the average dwell time changes depending on other factors (e.g., time of day, day of the week, season, temperature, traffic, etc.). In some embodiments, the parking space status module 304 uses the user’s calendar information 302 (e.g., haircut) and location trends 318 (e.g., average dwell time for users getting a haircut during that time period it 20 minutes) to determine the parking space status 306 (e.g., “Will be available in 20 minutes”).

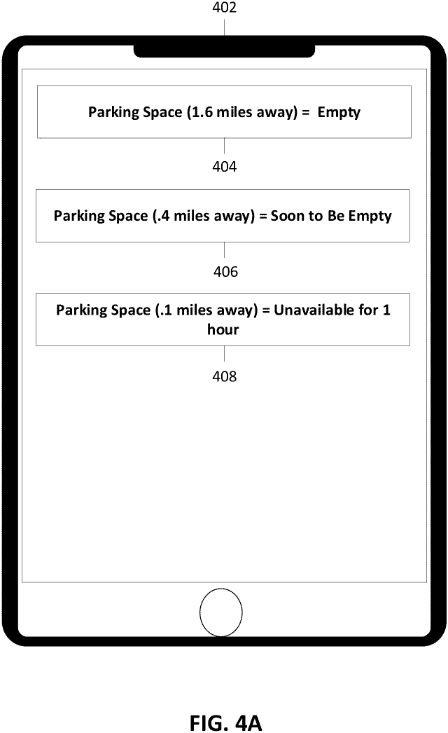

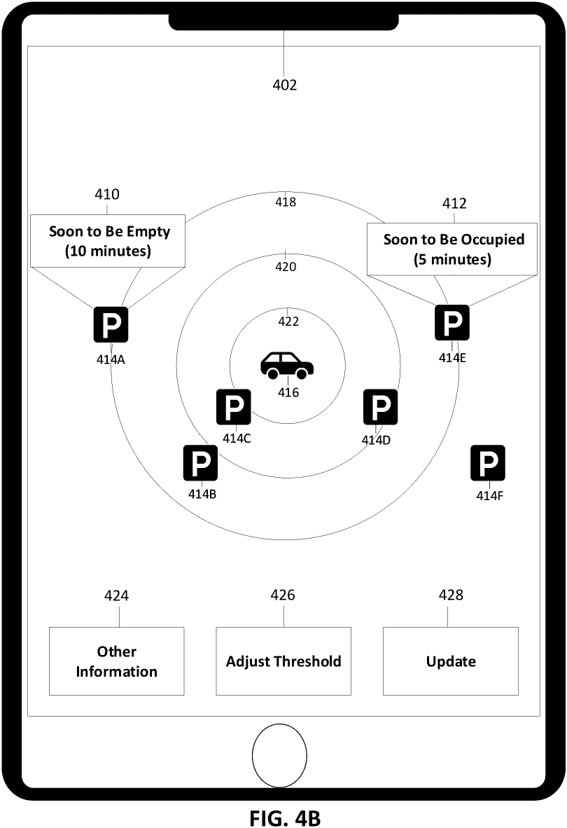

FIGS. 4A and 4B show illustrative diagrams of a user device 402 generating parking space status notifications, in accordance with some embodiments of the disclosure. Although a smartphone is used in this example, a user device 402 may be any device or devices capable of displaying a parking space status such as televisions, laptops, tablets, smartphones, and/or similar such devices.

FIG. 4A shows an embodiment where the user device 402 receives one or more notifications indicating one or more parking space statuses. In some embodiments, a first notification 404 indicates a first parking space status, a second notification 406 indicates a second parking space status, and a third notification 408 indicates a third parking space status. In some embodiments, a notification is transmitted to the user device 402 when a parking space status is generated. For example, if a first EVCS determines that a first parking space is available, it may transmit the first notification 404 to the user device 402. In some embodiments, a notification is transmitted to the user device 402 when a parking space status is updated. For example, if a second EVCS determines that a second parking space has an electric vehicle that is going to be leaving soon based on a user activity, the second EVCS may transmit the second notification 406 to the user device 402. In some embodiments, the most recent parking space status is transmitted to the user device 402. In some embodiments, the parking space status corresponding to the parking space that is the closest to the user device 402 is transmitted to the user device 402. In some embodiments, the parking space status corresponding to the parking space that is the closest to the user device 402 and is available and/or is going to be available within a threshold time period is transmitted to the user device 402. In some embodiments, a user is able to select notification settings relating to a first time period and a first threshold relating to available parking spots. For example, a user of the user device 402 may select parking spaces that are available and/or will be available within one mile in the next five minutes. In some embodiments, one or more EVCSs, servers, and/or similar such devices transmit the notifications to the user device 402.

In some embodiments, one or more notifications (e.g., first notification 404, second notification 406, third notification 408, etc.) may be transmitted to the user device 402 based on one or more factors (e.g., proximity, queue, auction, electric vehicle information, user information, etc.). In some embodiments, one or more notifications related to a first location are transmitted to the user device 402 when the user device 402 is within a threshold distance of the first location. In some embodiments, if an electric vehicle associated with the user device 402 meets a first parameter, one or more notifications are transmitted to the user device 402. For example, if the electric vehicle associated with the user device 402 has a 5% battery charge, the one or more notifications may be transmitted to the user device 402. In some embodiments, only notifications relating to parking spaces within a threshold distance of the user device 402 are transmitted, wherein the threshold distance relates to the distance the electric vehicle is able to travel given the percentage of battery charge. In some embodiments, one or more notifications are transmitted to the user device 402 based on user information associated with the user device 402. For example, if the user information associated with the user device 402 indicates that the user has an event scheduled at a first location, notifications relating to parking spaces within a threshold distance of the event may be transmitted to the user device 402. In some embodiments, one or more notifications are sent to user devices subscribed to a notification service. In some embodiments, one or more notifications are sent to user devices belonging to users who pay for the notifications. In some embodiments, a user can select one or more notifications to receive additional information. For example, a user may select the first notification 404 and see the exact location of the parking space. In some embodiments, a user can select a notification and receive directions to the parking space corresponding to the notification.

FIG. 4B shows an embodiment where a user launches a parking space application on a user device 402. In some embodiments, the user device 402 displays one or more parking spaces (e.g., parking spaces 414A-F) and/or parking space statuses (e.g., first parking space status 410, second parking space status 412, etc.) located within a threshold distance of the user’s location 416. The user’s location 416 may be determined using a global positioning system, cell tower data, Wi-Fi hotspot information, user profile information, and/or similar such information. In some embodiments, the first parking space status 410 reflects the parking space status of the first parking space 414A. In some embodiments, the parking space statuses (e.g., first parking space status 410, second parking space status 412, etc.) change color, shape, animation, to indicate the parking space status. Although the parking space statuses are shown as banners, similar such indications can be used. For example, the parking spaces 414A-F may change color, shape, animation, icon, etc., based on the associated parking space status.

In some embodiments, the user device 402 displays an “Other Information” option 424. A user can select the other information option 424 to view other parking space-status related information (e.g., parking space statuses in other locations, parking space statuses trends, etc.). In some embodiments, the user equipment device 402 displays an “Adjust Threshold” option 426. In some embodiments, the user can select the adjust threshold option 426 to cause the user device 402 to display parking spaces (e.g., parking spaces 414A-F) and/or parking space statuses (e.g., first parking space status 410, second parking space status 412, etc.) located within a different threshold distance of the user’s location 416. In some embodiments, the user can select the adjust threshold option 426 to cause the user device 402 to display only certain categories of parking space statuses (e.g., “Available,” “Soon to be available,” “Occupied,” “Soon to be occupied,” etc.). In some embodiments, the user can select the adjust threshold option 426 to cause the user device 402 to display certain categories of spaces statuses during a certain time period, for example, all parking spaces that are available or soon to be available for the next five minutes. In some embodiments, the user equipment device 402 displays an “Update” option 428. In some embodiments, the user can select the update option 428 to cause the user device 402 to refresh the parking spaces (e.g., parking spaces 414A-F) and/or parking space statuses (e.g., first parking space status 410, second parking space status 412, etc.). In some embodiments, the parking spaces (e.g., parking spaces 414A-F) and/or parking space statuses (e.g., first parking space status 410, second parking space status 412, etc.) are updated periodically (e.g., every 30 seconds) without the user’s input.

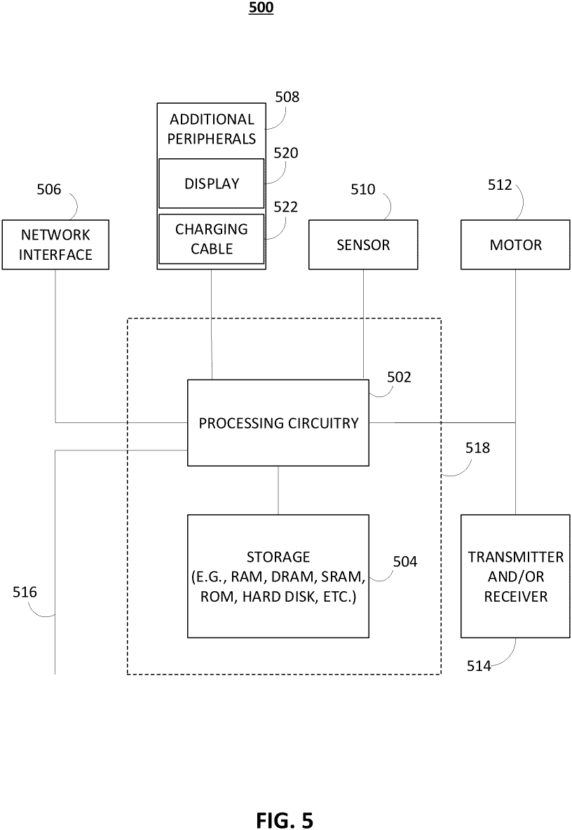

FIG. 5 shows an illustrative block diagram of an EVCS system 500, in accordance with some embodiments of the disclosure. In particular, EVCS system 500 of FIG. 5 may be the EVCSs depicted in FIG. 1. In practice, and as recognized by those of ordinary skill in the art, items shown separately could be combined and some items could be separated. In some embodiments, not all shown items must be included in EVCS 500. In some embodiments, EVCS 500 may comprise additional items.

The EVCS system 500 can include processing circuitry 502, which includes one or more processing units (processors or cores), storage 504, one or more networks or other communications network interfaces 506, additional peripherals 508, one or more sensors 510, a motor 512 (configured to retract a portion of a charging cable), one or more wireless transmitters and/or receivers 514, and one or more input/output (“I/O”) paths 516. I/O paths 516 may use communication buses for interconnecting the described components. I/O paths 516 can include circuitry (sometimes called a chipset) that interconnects and controls communications between system components. EVCS 500 may receive content and data via I/O paths 516. The I/O path 516 may provide data to control circuitry 518, which includes processing circuitry 502 and a storage 504. The control circuitry 518 may be used to send and receive commands, requests, and other suitable data using the I/O path 516. The I/O path 516 may connect the control circuitry 518 (and specifically the processing circuitry 502) to one or more communications paths. I/O functions may be provided by one or more of these communications paths but are shown as a single path in FIG. 5 to avoid overcomplicating the drawing.

The control circuitry 518 may be based on any suitable processing circuitry such as the processing circuitry 502. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The identifying of a parking space status functionality can be at least partially implemented using the control circuitry 518. The identifying of a parking space status functionality described herein may be implemented in or supported by any suitable software, hardware, or combination thereof. The identifying of a parking space status functionality can be implemented on user equipment, on remote servers, or across both.

The control circuitry 518 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 504 that is part of the control circuitry 518. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 504 includes one or more storage devices remotely located, such as a database of a server system that is in communication with EVCS 500. In some embodiments, the storage 504, or alternatively the non-volatile memory devices within the storage 504, includes a non-transitory computer-readable storage medium.

In some embodiments, storage 504 or the computer-readable storage medium of the storage 504 stores an operating system, which includes procedures for handling various basic system services and for performing hardware-dependent tasks. In some embodiments, storage 504 or the computer-readable storage medium of the storage 504 stores a communications module, which is used for connecting EVCS 500 to other computers and devices via the one or more communication network interfaces 506 (wired or wireless), such as the Internet, other wide area networks, local area networks, metropolitan area networks, and so on. In some embodiments, storage 504 or the computer-readable storage medium of the storage 504 stores a media item module for selecting and/or displaying media items on the display(s) 520 to be viewed by passersby and users of EVCS 500. In some embodiments, storage 504 or the computer-readable storage medium of the storage 504 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, storage 504 or a computer-readable storage medium of the storage 504 stores a parking space status module (e.g., parking space status module 204). In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 504 stores a subset of the modules and data structures identified above. In some embodiments, the storage 504 may store additional modules or data structures not described above.

In some embodiments, EVCS 500 comprises additional peripherals 508 such as displays 520 for displaying content and charging cable 522. In some embodiments, the displays 520 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

In some embodiments, EVCS 500 comprises one or more sensors 510 such as cameras (e.g., camera, described above with respect to FIGS. 1, 3A and/or 3B), ultrasound sensors, depth sensors, IR cameras, RGB cameras, PIR cameras, thermal IR, proximity sensors, radar, tension sensors, NFC sensors, and/or any combination thereof. In some embodiments, the one or more sensors 510 are for detecting whether external objects are within a region proximal to EVCS 500, such as living and nonliving objects, and/or the status of EVCS 500 (e.g., available, occupied, etc.) in order to perform an operation, such as determining a vehicle characteristic, user information, region status, etc.

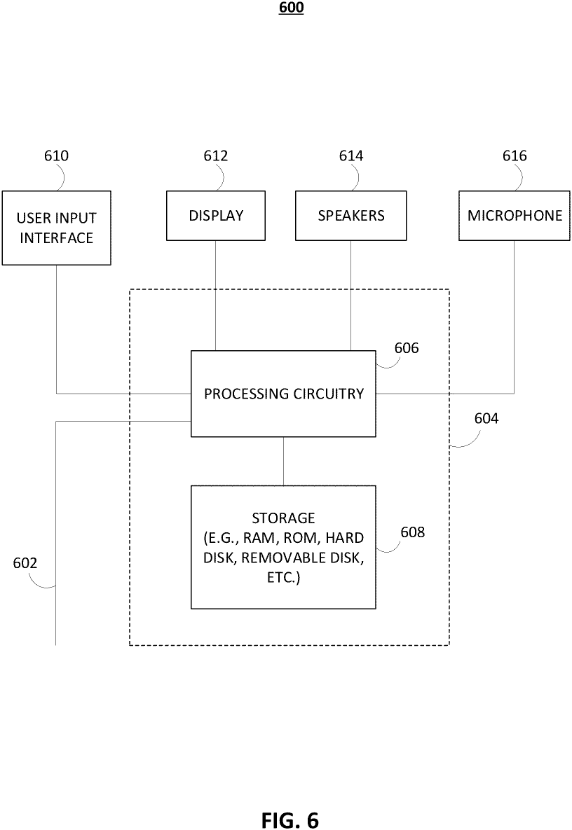

FIG. 6 shows an illustrative block diagram of a user equipment device system, in accordance with some embodiments of the disclosure. In practice, and as recognized by those of ordinary skill in the art, items shown separately could be combined and some items could be separated. In some embodiments, not all shown items must be included in device 600. In some embodiments, device 600 may comprise additional items. In an embodiment, the user equipment device 600 is the same user equipment device displayed in FIG. 1. The user equipment device 600 may receive content and data via I/O path 602. The I/O path 602 may provide audio content (e.g., broadcast programming, on-demand programming, Internet content, content available over a local area network (LAN) or wide area network (WAN), and/or other content) and data to control circuitry 604, which includes processing circuitry 606 and a storage 608. The control circuitry 604 may be used to send and receive commands, requests, and other suitable data using the I/O path 602. The I/O path 602 may connect the control circuitry 604 (and specifically the processing circuitry 606) to one or more communications paths. I/O functions may be provided by one or more of these communications paths but are shown as a single path in FIG. 6 to avoid overcomplicating the drawing.

The control circuitry 604 may be based on any suitable processing circuitry such as the processing circuitry 606. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client/server-based embodiments, the control circuitry 604 may include communications circuitry suitable for communicating with one or more servers that may at least implement the described allocation of services functionality. The instructions for carrying out the above-mentioned functionality may be stored on the one or more servers. Communications circuitry may include a cable modem, an ISDN modem, a DSL modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 608 that is part of the control circuitry 604. Storage 608 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called a personal video recorder, or PVRs), solid-state devices, quantum storage devices, gaming consoles, gaming media, or any other suitable fixed or removable storage devices, and/or any combination of the same. The storage 608 may be used to store various types of content described herein. Nonvolatile memory may also be used (e.g., to launch a boot-up routine and other instructions). Cloud-based storage may be used to supplement the storage 608 or instead of the storage 608.

The control circuitry 604 may include audio-generating circuitry and tuning circuitry, such as one or more analog tuners, audio generation circuitry, filters or any other suitable tuning or audio circuits or combinations of such circuits. The control circuitry 604 may also include scaler circuitry for upconverting and down converting content into the preferred output format of the user equipment device 600. The control circuitry 604 may also include digital-to-analog converter circuitry and analog-to-digital converter circuitry for converting between digital and analog signals. The tuning and encoding circuitry may be used by the user equipment device 600 to receive and to display, to play, or to record content. The circuitry described herein, including, for example, the tuning, audio-generating, encoding, decoding, encrypting, decrypting, scaler, and analog/digital circuitry, may be implemented using software running on one or more general purpose or specialized processors. If the storage 608 is provided as a separate device from the user equipment device 600, the tuning and encoding circuitry (including multiple tuners) may be associated with the storage 608.

The user may utter instructions to the control circuitry 604 that are received by the microphone 616. The microphone 616 may be any microphone (or microphones) capable of detecting human speech. The microphone 616 is connected to the processing circuitry 606 to transmit detected voice commands and other speech thereto for processing. In some embodiments, voice assistants (e.g., Siri, Alexa, Google Home, and similar such voice assistants) receive and process the voice commands and other speech.

The user equipment device 600 may optionally include an interface 610. The interface 610 may be any suitable user interface, such as a remote control, mouse, trackball, keypad, keyboard, touch screen, touchpad, stylus input, joystick, or other user input interfaces. A display 612 may be provided as a stand-alone device or integrated with other elements of the user equipment device 600. For example, the display 612 may be a touchscreen or touch-sensitive display. In such circumstances, the interface 610 may be integrated with or combined with the microphone 616. When the interface 610 is configured with a screen, such a screen may be one or more of a monitor, television, liquid crystal display (LCD) for a mobile device, active matrix display, cathode ray tube display, light-emitting diode display, organic light-emitting diode display, quantum dot display, or any other suitable equipment for displaying visual images. In some embodiments, the interface 610 may be HDTV-capable. In some embodiments, the display 612 may be a 3D display. The speaker (or speakers) 614 may be provided as integrated with other elements of user equipment device 600 or may be a stand-alone unit. In some embodiments, the display 612 may be outputted through speaker 614.

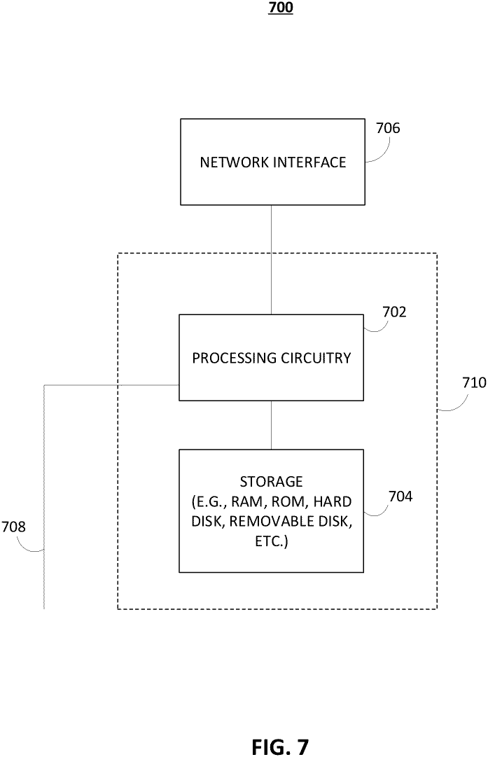

FIG. 7 shows an illustrative block diagram of a server system 700, in accordance with some embodiments of the disclosure. Server system 700 may include one or more computer systems (e.g., computing devices), such as a desktop computer, a laptop computer, and a tablet computer. In some embodiments, the server system 700 is a data server that hosts one or more databases (e.g., databases of images or videos), models, or modules or may provide various executable applications or modules. In practice, and as recognized by those of ordinary skill in the art, items shown separately could be combined and some items could be separated. In some embodiments, not all shown items must be included in server system 700. In some embodiments, server system 700 may comprise additional items.

The server system 700 can include processing circuitry 702 that includes one or more processing units (processors or cores), storage 704, one or more networks or other communications network interfaces 706, and one or more I/O paths 708. I/O paths 708 may use communication buses for interconnecting the described components. I/O paths 708 can include circuitry (sometimes called a chipset) that interconnects and controls communications between system components. Server system 700 may receive content and data via I/O paths 708. The I/O path 708 may provide data to control circuitry 710, which includes processing circuitry 702 and a storage 704. The control circuitry 710 may be used to send and receive commands, requests, and other suitable data using the I/O path 708. The I/O path 708 may connect the control circuitry 710 (and specifically the processing circuitry 702) to one or more communications paths. I/O functions may be provided by one or more of these communications paths but are shown as a single path in FIG. 7 to avoid overcomplicating the drawing.

The control circuitry 710 may be based on any suitable processing circuitry such as the processing circuitry 702. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 704 that is part of the control circuitry 710. Storage 704 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 704 or the computer-readable storage medium of the storage 704 stores an operating system, which includes procedures for handling various basic system services and for performing hardware-dependent tasks. In some embodiments, storage 704 or the computer-readable storage medium of the storage 704 stores a communications module, which is used for connecting the server system 700 to other computers and devices via the one or more communication network interfaces 706 (wired or wireless), such as the Internet, other wide area networks, local area networks, metropolitan area networks, and so on. In some embodiments, storage 704 or the computer-readable storage medium of the storage 704 stores a web browser (or other application capable of displaying web pages), which enables a user to communicate over a network with remote computers or devices. In some embodiments, storage 704 or the computer-readable storage medium of the storage 704 stores a database for storing information on electric vehicle charging stations, their locations, media items displayed at respective electric vehicle charging stations, a number of each type of impression count associated with respective electric vehicle charging stations, user profiles, and so forth.

In some embodiments, executable modules, applications, or sets of procedures may be stored in one or more of the previously mentioned memory devices and correspond to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 704 stores a subset of the modules and data structures identified above. In some embodiments, the storage 704 may store additional modules or data structures not described above.

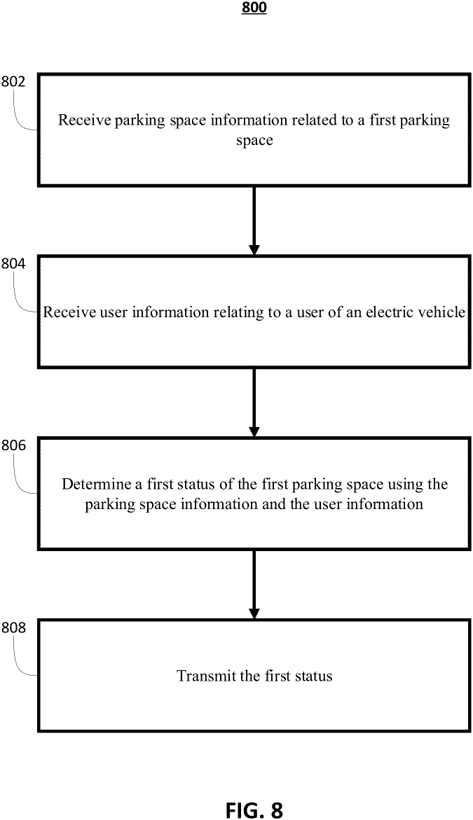

FIG. 8 is an illustrative flowchart of a process 800 for identifying the status of a parking space, in accordance with some embodiments of the disclosure. Process 800 may be performed by physical or virtual control circuitry, such as control circuitry 518 of EVCS (FIG. 5). In some embodiments, some steps of process 800 may be performed by one of several devices (e.g., user device 600, server 700, etc.).

At step 802, control circuitry receives parking space information related to a first parking space. In some embodiments, the control circuitry uses one or more sensors to capture parking space information. For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof.

At step 804, control circuitry receives user information (e.g., user location, user calendars, user purchases, user patterns, etc.) relating to a user of an electric vehicle. In some embodiments, the electric vehicle is determined using the parking space information. In some embodiments, the electric vehicle and/or user of the electric vehicle is identified when the user presents some credentials (e.g., password, pin, biometrics, device, item, etc.) to request charging of their electric vehicle. In some embodiments, the credentials may be automatically inputted. In some embodiments, characteristics of the electric vehicle are used as credentials. In some embodiments, the control circuitry uses the credentials to identify a user profile associated with the user. In some embodiments, the user profile stores information about the user.

In some embodiments, the control circuitry receives the user information in conjunction with receiving a request to charge the electric vehicle. In some embodiments, the control circuitry requests the user information from a database and/or server. In some embodiments, the control circuitry requests user information by submitting a request to a database and/or server wherein the request identifies the electric vehicle and/or a user of the electric vehicle. In some embodiments, the control circuitry receives the user information from a database, the user, and or a third-party provider.

At step 806, control circuitry determines a first status of the first parking space using the parking space information and the user information. In some embodiments, the control circuitry determines that the first status (e.g., “Occupied”) based on the electric vehicle being in the parking space (parking space information) and the user not being near the electric vehicle (user information). In some embodiments, the control circuitry can use more than one type of user information or parking space information to determine the first status. In some embodiments, control circuitry weights different user information and parking space information according to significance. For example, a first user information may indicate that the user has an upcoming event in one hour, and a second user information may indicate that the user made a purchase two weeks ago. In some embodiments, the control circuitry weights the first user information higher than the second user information and bases the first status on the first user information.

In some embodiments, the control circuitry uses the received user information to determine a time period for the first status. In some embodiments, the control circuitry accesses a database with entries that associate user information with estimated time periods. In some embodiments, a first entry indicates that the user loading groceries (user information) into the electric vehicle parked in the first parking space corresponds to approximately 10 minutes (time period) until the electric vehicle leaves the parking space. In some embodiments, one or more entries specify that users with children loading groceries correspond to a longer time period than users without children loading groceries. In some embodiments, the database comprises customized entries based on certain users. In some embodiments, the control circuitry includes the estimated time period in and/or along with the first status.

At step 808, control circuitry transmits the first status. In some embodiments, the control circuitry transmits the first status to a second user and/or group of users based on one or more factors (e.g., proximity, queue, auction, electric vehicle information, user information, etc.).

In some embodiments, control circuitry receives a condition of a second electric vehicle. In some embodiments, the condition is part of a charging request sent by the second electric vehicle. In some embodiments, the condition may be related to vehicle information (e.g., location of the electric vehicle, battery charge of the electric vehicle, time of charge required, etc.). In some embodiments, the condition may be related to additional information such as queue of charging requests, auction of parking spaces, user information, etc. In some embodiments, the condition is part of a charging request sent by a user device associated with the second electric vehicle. In some embodiments, the condition is part of a first charging request of a plurality of charging requests. For example, the control circuitry may receive charging requests from a plurality of electric vehicles, wherein one or more of the charging requests have conditions relating to the electric vehicle associated with the charging request.

In some embodiments, control circuitry transmits the first status to the second electric vehicle based on the condition of the second electric vehicle. In some embodiments, the control circuitry transmits the first status to the second electric vehicle because the second electric vehicle is within a threshold distance (e.g., one mile) of the location of the parking space. In some embodiments, the control circuitry transmits the first status to the second electric vehicle because the second electric vehicle is subscribed to a spot notification service. In some embodiments, the control circuitry transmits the first status to the second electric vehicle because the second electric vehicle has a charge below a first threshold (e.g., less than 20% charged). In some embodiments, the control circuitry transmits the first status to the second electric vehicle because there is a queue of electric vehicles requesting parking spaces and the second electric vehicle is next in the queue to receive a parking space. In some embodiments, the control circuitry transmits the first status to a database comprising a plurality of entries listing parking space statuses and one or more devices associated with the database sends the first status to the second electric vehicle.

In some embodiments, the control circuitry weights one or more conditions to determine an electric vehicle to receive the first status. For example, the percent charge of an electric vehicle may be weighted lower than a user bidding the highest amount for an EVCS parking space. In some embodiments, a user device and/or an electric vehicle transmits a charging request using one or more data packets (e.g., using IPv6) to the one or more devices maintaining a database comprising a plurality of entries listing parking space statuses. In some embodiments, machine learning is utilized to determine that the first status of the first parking space should be transmitted to the second electric vehicle.

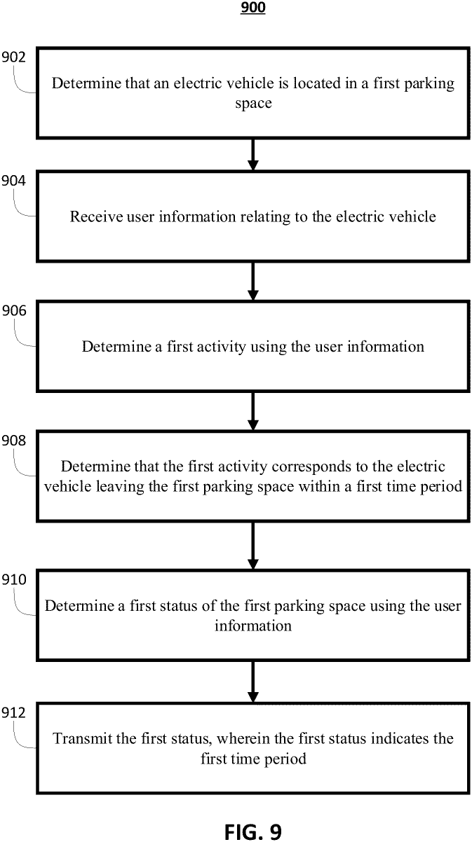

FIG. 9 is another illustrative flowchart of a process 900 for identifying the status of a parking space, in accordance with some embodiments of the disclosure. Process 900 may be performed by physical or virtual control circuitry, such as control circuitry 518 of EVCS 500 (FIG. 5). In some embodiments, some steps of process 900 may be performed by one of several devices (e.g., user device 600, server 700, etc.).

At step 902, control circuitry determines that an electric vehicle is located in a first parking space. In some embodiments, the control circuitry makes this determination using parking space information related to the first parking space. In some embodiments, the control circuitry uses one or more sensors to capture parking space information. For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof.

At step 904, control circuitry receives user information relating to the electric vehicle. In some embodiments, the control circuitry uses the same or similar methodologies described in step 804 above. In some embodiments, the control circuitry uses electric vehicle information related to the electric vehicle to determine user information. In some embodiments, the control circuitry requests user information by submitting a request to a database and/or server wherein the request identifies the electric vehicle and/or a user of the electric vehicle. In some embodiments, the control circuitry receives the user information from a database, the user, and/or a third-party provider.

At step 906, control circuitry determines a first activity using the user information. In some embodiments, the control circuitry associates certain types of user information with activity types. For example, the control circuitry may associate user information relating to a user purchasing an item with a purchasing activity. In another example, the control circuitry may associate user information relating to a user loading groceries into the electric vehicle as a loading activity. In some embodiments, the control circuitry uses one or more machine learning algorithms to determine the first activity using the user information. In some embodiments, the control circuitry accesses a database comprising entries that match user information with activity types. For example, an entry may associate user information related to a user crossing a geofence located at the exit of a location as a departure activity. In some embodiments, user information can correspond to more than one activity type. In some embodiments, an activity type can correspond to more than one user information.

At step 908, control circuitry determines that the first activity corresponds to the electric vehicle leaving the first parking space within a first time period. In some embodiments, the control circuitry accesses a database with entries that associate activities with estimated time periods. In some embodiments, the database is the same database described in step 906 above. In some embodiments, a first entry indicates that the first activity (e.g., loading activity) corresponds to a first time period (e.g., approximately 10 minutes). In some embodiments, the first time period is based on past user behavior. For example, if the user takes an average of 10 minutes to load the electric vehicle, the first time period may be approximately 10 minutes. In some embodiments, the first time period is based on the past behaviors of users. For example, if the recorded average of all users indicates that it takes about 10 minutes to load the electric vehicle then the first time period may be approximately 10 minutes. In some embodiments, a second entry indicates that a second activity (e.g., purchase activity) corresponds to a second time period (e.g., approximately five minutes) until the electric vehicle leaves the parking space. In some embodiments, the second time period is based on the user’s past behavior. For example, because the user usually takes about five minutes to walk to the electric vehicle from the store the second time period may be five minutes. In some embodiments, the second time period is based on the past behaviors of users. In some embodiments, the entries provide additional granularity. For example, entries may specify that loading activities when children are present correspond to a longer time period than loading activities when children are not present.

At step 910, control circuitry determines a first status of the first parking space using the parking space information and the user information. In some embodiments, this step uses the same or similar methodologies described in step 806 above.

At step 912, control circuitry transmits the first status, wherein the first status indicates the first time period. In some embodiments, the control circuitry transmits the first status comprising the first time period to a second user and/or group of users based on one or more factors (e.g., proximity, queue, auction, electric vehicle information, user information, etc.). In some embodiments, the control circuitry transmits the first status comprising the first time period to a second user who requires a parking space to charge their electric vehicle within a threshold distance (e.g., one mile). In some embodiments, the control circuitry transmits the first status comprising the first time period to a group of users who subscribe to a spot notification service. In some embodiments, a group of users pay a higher premium to receive the first status, which includes the first time period. In some embodiments, the control circuitry transmits the first status comprising the first time period to one or more users with electric vehicles having a charge below a first threshold (e.g., less than 20% charged). In some embodiments, there is a queue of users requesting parking spaces, and the control circuitry transmits the first status comprising the first time period to a second user who is next in the queue to receive a parking space. In some embodiments, the control circuitry transmits the first status comprising the first time period to a database comprising a plurality of entries listing parking space statuses.

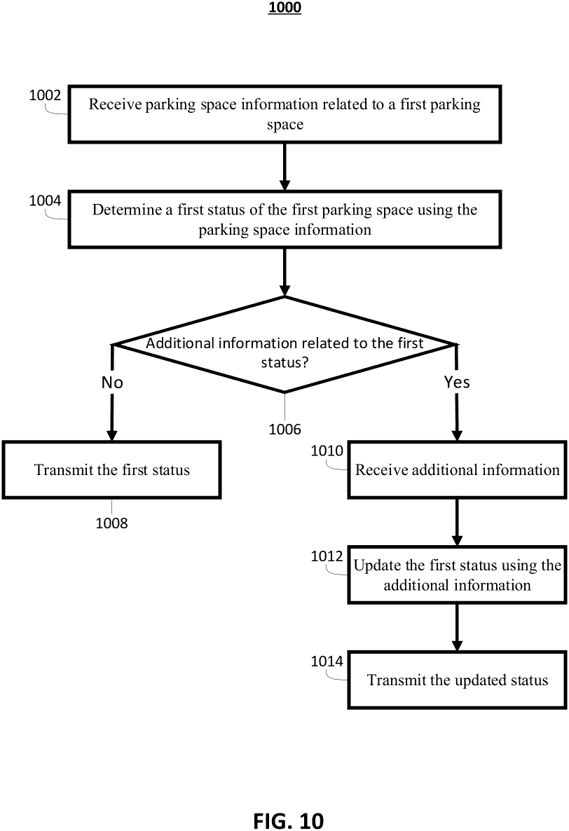

FIG. 10 is another illustrative flowchart of a process 1000 for identifying the status of a parking space, in accordance with some embodiments of the disclosure. Process 1000 may be performed by physical or virtual control circuitry, such as control circuitry 518 of EVCS (FIG. 5). In some embodiments, some steps of process 1000 may be performed by one of several devices (e.g., user device 600, server 700, etc.).

At step 1002, control circuitry receives parking space information related to a first parking space. In some embodiments, the control circuitry uses one or more sensors to capture parking space information. For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof.

At step 1004, control circuitry determines a first status of the first parking space using the parking space information. In some embodiments, if the control circuitry determines that a first electric vehicle is located in the first parking space, the control circuitry can determine the first parking space status (e.g., “Occupied”). In another embodiment, if the control circuitry determines that a first electric vehicle is not located in the first parking space, the control circuitry can determine the first parking space status (e.g., “Available”).

At step 1006, control circuitry determines if there is additional information related to the first status. In some embodiments, additional information is obtained from the one or more sensors (e.g., camera 116). In some embodiments, the additional information relates to the first status. For example, if the first status is “Available,” the control circuitry may determine if a first user has claimed the first parking space (additional information). In some embodiments, the control circuitry allows one or more users to claim an available parking space. If there is additional information, then the process continues to step 1010. In another example, if the first status is “Occupied,” the control circuitry may determine if there is user information related to the first status (additional information). In some embodiments, user information may be categorized as relating to a first status or not relating to a first status. If there is user information related to the first status (additional information), then the process continues to step 1010. In some embodiments, if there is not user information related to the first status, then the control circuitry determines that there is no additional information. If there is no additional information, then the process continues to step 1008.

At step 1008, control circuitry transmits the first status. In some embodiments, this step uses the same or similar methodologies described in step 808 above.

At step 1010, control circuitry receives the additional information. In some embodiments, the additional information relates to the one or more users who claimed the first parking spot. In some embodiments, the additional information relates to user information related to the first status. In some embodiments, the control circuitry requests the additional information by submitting a request to a database and/or server wherein the request identifies the electric vehicle and/or a user of the electric vehicle, wherein the electric vehicle is in the parking space or has claimed the parking space. In some embodiments, the control circuitry receives the additional information from a database, a user, and or a third-party provider. In some embodiments, if the additional information relates to user information, the user information can be received using the same or similar methodologies described in step 804 above.

At step 1012, control circuitry updates the first status using the additional information. In some embodiments, the additional information relates to a first activity. For example, based on the additional information (e.g., a user loading groceries), the control circuitry updates the first status (e.g., “Occupied”) to an updated parking space status (e.g., “Soon to be available”). In some embodiments, the control circuitry uses the additional information to determine an estimated time period for the updated status.

At step 1014, control circuitry transmits the updated status. In some embodiments, the control circuitry transmits the updated status using the same or similar methodologies describes in transmitting the first status described in step 808 above.

It is contemplated that some suitable steps or suitable descriptions of FIGS. 8-10 may be used with other suitable embodiments of this disclosure. In addition, some suitable steps and descriptions described in relation to FIGS. 8-10 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-7 could be used to perform one or more of the steps in FIGS. 8-10.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
determining, by an electric vehicle charging station, that an electric vehicle is located in a first parking space;
receiving, by the electric vehicle charging station, user information relating to the electric vehicle;
determining, by the electric vehicle charging station, a first status of the first parking space using the received user information; and
transmitting, by the electric vehicle charging station, the first status.

2. The method of claim 1, wherein determining a first status of the first parking space further comprises:
determining that the user information corresponds to a first activity; and
determining that the first activity corresponds to an action indicating that the electric vehicle will leave the first parking space within a first time period.

3. The method of claim 2, wherein the user information is collected from one or more sensors of the electric vehicle charging station.

4. The method of claim 2, wherein the first status indicates that the first parking space will be available within a first time period.

5. The method of claim 2, wherein the first status is transmitted to a user of a second electric vehicle.

6. The method of claim 2, wherein electric vehicle charging station determines that the electric vehicle is located in a first parking space using the one or more sensors of the electric vehicle charging station.

7. The method of claim 2, wherein the user information corresponds to one or more events in a calendar and the calendar is associated with a user of the electric vehicle.

8. The method of claim 2, wherein the user information corresponds to a user making a purchase and the user is associated with the electric vehicle.

9. The method of claim 2, wherein the user information corresponds to a device crossing a first geofence, wherein the device is associated with the electric vehicle.

10. The method of claim 2, wherein the user information corresponds to a profile associated with a user of the electric vehicle and the profile comprises one or more past estimated charge times.

11. An apparatus comprising:
control circuitry; and
at least one memory including computer program code for one or more programs, the at least one memory and the computer program code configured to, with the control circuitry, cause the apparatus to perform at least the following:
determine that an electric vehicle is located in a first parking space;
receive user information relating to the electric vehicle;
determine a first status of the first parking space using the received user information; and
transmit the first status.

12. The apparatus of claim 11, wherein the apparatus is further caused, when determining a first status of the first parking space, to:
determine that the user information corresponds to a first activity; and
determine that the first activity corresponds to an action indicating that the electric vehicle will leave the first parking space within a first time period.

13. The apparatus of claim 12, wherein the apparatus is further caused to collect user information using one or more sensors.

14. The apparatus of claim 12, wherein the first status indicates that the first parking space will be available within a first time period.

15. The apparatus of claim 12, wherein the first status is transmitted to a user of a second electric vehicle.

16. The apparatus of claim 12, wherein the apparatus is further caused to determine that the electric vehicle is located in a first parking space using one or more sensors.

17. The apparatus of claim 12, wherein the user information corresponds to one or more events in a calendar and the calendar is associated with a user of the electric vehicle.

18. The apparatus of claim 12, wherein the user information corresponds to a user making a purchase and the user is associated with the electric vehicle.

19. The apparatus of claim 12, wherein the user information corresponds to a device crossing a first geofence, wherein the device is associated with the electric vehicle.

20. The apparatus of claim 12, wherein the user information corresponds to a profile associated with a user of the electric vehicle and the profile comprises one or more past estimated charge times.

21-30. (canceled)
